(19) United States
(12) Patent Application Publication
(10) Pub. No.: US 2006/0092662 A1
(43) Pub. Date: May 4, 2006

(54) Backlight unit and liquid crystal display employing the same

(76) Inventors: Ji-whan Noh, Suwon-si (KR); Ju-seong Hwang, Cheonan-si (KR); Joon-chan Park, Anyang-si (KR); Il-yong Jung, Suwon-si (KR)

Correspondence Address: STANZIONE & KIM, LLP, 919 18TH STREET, N.W., SUITE 440, WASHINGTON, DC, 20006, US

(21) Appl. No.: 11/262,902

(22) Filed: Nov. 1, 2005

(30) Foreign Application Priority Data
Nov. 3, 2004 (KR) 2004-88919

(51) Int. Cl. F21V 7/04

(52) U.S. Cl. 362/607; 362/613

(57) ABSTRACT

A backlight unit and an LCD apparatus employing the same. The backlight unit includes: a base plate, a plurality of light emitting units arranged on the base plate to form at least one line, an optical plate disposed above the plurality of light emitting units, and a light transmission diffusion plate disposed on the optical plate to diffuse and transmit incident light. The optical plate includes: a plurality of reflection mirrors formed at a lower surface thereof to face the plurality of light emitting units to reflect light directly emitted upward from the plurality of light emitting device units, and a saw-tooth reflection/refraction pattern formed at an upper surface thereof to spread incident light at a wide angle.

### CROSS-REFERENCE TO RELATED APPLICATIONS

This application claims the benefit of Korean Patent Application No. 2004-88919, filed on Nov. 3, 2004, in the Korean Intellectual Property Office, the disclosure of which is incorporated herein in its entirety by reference.

### BACKGROUND OF THE INVENTION

1. Field of the Invention

The present general inventive concept relates to a backlight unit and a liquid crystal display employing the same, and more particularly, to a direct light type backlight unit and a liquid crystal display employing the same.

2. Description of the Related Art

A liquid crystal display (LCD) is a passive flat panel display that forms an image without using self-luminescence. Instead, the LCD uses light incident from an outside source. In particular, a backlight unit is disposed at a rear of the LCD to irradiate light toward a liquid crystal panel thereof.

Backlight units can be classified as direct light type backlight units in which light is emitted from a plurality of light sources disposed directly below the liquid crystal panel and is irradiated thereto, and edge light type backlight units in which light is emitted from a light source disposed on a sidewall of a light guide panel and is transmitted to the liquid crystal panel. The direct light type backlight units may use a light emitting diode, which emits Lambertian light as a point light source.

The backlight unit is provided with a light diffusion plate for diffusing light emitted from a light source such that the light is uniformly irradiated onto the liquid crystal panel.

When using the light emitting diode as the light source(s) in the direct light type backlight unit, a light transmission diffusion plate is disposed above the light source(s). In order to more uniformly diffuse the light emitted from the light source(s), it becomes necessary to increase a distance between the light source(s) and the light transmission diffusion plate. As a result, a thickness of the backlight unit increases.

Thus, if the backlight unit is made thicker, an LCD employing the backlight unit (e.g., an LCD TV) also becomes thicker. As a result, the LCD does not satisfy a desired slim design requirement.

### SUMMARY OF THE INVENTION

The present general inventive concept provides a direct light type backlight unit having a thickness that is sufficiently thin to meet desired slim design requirements and has an improved structure to uniformly irradiate light, and an LCD employing the same.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a backlight unit usable with a display panel, the backlight unit including a base plate, a plurality of light emitting units arranged on the base plate to form at least one line, an optical plate disposed above the plurality of light emitting units, and a light guide panel transmission diffusion plate disposed on the optical plate to diffuse and transmit incident light. The optical plate includes a plurality of reflection mirrors formed at a lower surface thereof to face the plurality of light emitting units to reflect light emitted directly upward by the plurality of light emitting units, and a saw-tooth reflection/refraction pattern formed at an upper surface thereof to spread incident light at a wide angle.

The saw-tooth reflection/refraction pattern may include a first local plane inclined to totally internally reflect at least part of the incident light and a second local plane to form a saw-tooth shape together with the first local plane, and the first and second local planes being arranged in stripes along the upper surface of the optical plate.

Each of the stripes in which the first and second local planes are arranged extend along a length direction that is parallel with the at least one line of the plurality of light emitting units.

The saw-tooth reflection/refraction pattern may include first pattern regions and second pattern regions alternately repeated such that the first local plane has an opposite inclination direction in the first pattern regions and the second pattern regions and the first and second pattern regions center on a line crossing a central axis of the plurality of light emitting units.

The first local plane in each of the first and second pattern regions may be inclined in a direction that extends away from the central axis of the plurality of light emitting units.

The second local plane may refract and transmit the incident light.

The first local plane may have an inclination angle with respect to the lower surface of the optical plate that is smaller than an inclination angle of the second local plane with respect to the lower surface of the optical plate.

The backlight unit may further include a light reflection-diffusion plate disposed on the base plate at a lower side of the plurality of light emitting units to diffuse and reflect the incident light toward the optical plate.

Each of the plurality of light emitting units may include a light emitting diode chip to generate light, and a collimator to collimate light generated by the light emitting diode chip.

The collimator may be a side emitter to direct incident light to travel in an approximate side direction.

The collimator may be shaped as a dome.

The backlight unit may further include at least one of a brightness enhancement film to enhance a directivity of light emitted from the light transmission diffusion plate and a polarization enhancement film to enhance a polarization efficiency of light incident from the light transmission diffusion plate.

The foregoing and/or other aspects of the present general inventive concept are also achieved by providing a backlight unit usable with a display panel, the backlight unit comprising a light source to generate light beams, and a refraction/reflection component to receive the generated light beams and to internally reflect a first one or more light beams and to refract a second one or more light beams to form a uniform light.

The foregoing and/or other aspects of the present general inventive concept are also achieved by providing a backlight unit usable with a display panel apparatus, the backlight unit comprising a base, an array of light sources disposed on the base to emit light beams in a predetermined direction, and an optical plate disposed adjacent to the array of light sources and including an entrance surface and an exit surface such that one or more of the light beams reflect one or more times between the entrance surface and the exit surface and then transmit in the predetermined direction through the exit surface.

The foregoing and/or other aspects of the present general inventive concept are also achieved by providing a direct type backlight unit usable with a display panel apparatus, the backlight unit comprising a base having a plurality of light sources arranged thereon to emit a plurality of light beams, and a reflection/refraction component disposed adjacent to the base and having a plurality of angled surfaces to receive the plurality of light beams, to reflectively scatter the light beams, and to output the scattered light beams as uniform light.

The foregoing and/or other aspects of the present general inventive concept are also achieved by providing an LCD apparatus including a liquid crystal panel, and a backlight unit to irradiate light toward the liquid crystal panel and having the characteristics described above.

The foregoing and/or other aspects of the present general inventive concept are also achieved by providing a display panel apparatus, comprising a display panel, and a backlight unit to irradiate the display panel. The backlight unit comprises a light source to generate light beams, and a refraction/reflection component to receive the generated light beams and to internally reflect a first one or more light beams and to refract a second one or more light beams to form a uniform light.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a schematic sectional view illustrating a backlight unit according to an embodiment of the present general inventive concept;

FIG. 2 is a plan view illustrating an exemplary arrangement of light emitting units of the backlight unit of FIG. 1 according to an embodiment of the present general inventive concept;

FIG. 3 is an enlarged sectional view illustrating a light emitting unit of the backlight unit of FIG. 1 according to an embodiment of the present general inventive concept;

FIG. 4 is a schematic perspective view illustrating an optical plate of the backlight unit of FIG. 1 according to an embodiment of the present general inventive concept;

FIG. 5 is a partial side sectional view illustrating the backlight unit of FIG. 1;

FIG. 6A is a schematic view illustrating a traveling path of light that is incident on a first local plane of a first pattern region ‘A’, and FIG. 6B is a schematic view illustrating a traveling path of light that is incident on a first local plane of a second pattern region ‘B’;

FIGS. 7A and 7B respectively illustrate an intensity distribution of light above an optical plate when a saw-tooth reflection/refraction pattern is not formed thereon and an intensity distribution of light above the optical plate when a saw-tooth reflection/refraction pattern is formed thereon;

FIG. 8 is a schematic sectional view illustrating a backlight unit according to another embodiment of the present general inventive concept; and

FIG. 9 schematically illustrates an LCD apparatus having a backlight unit according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

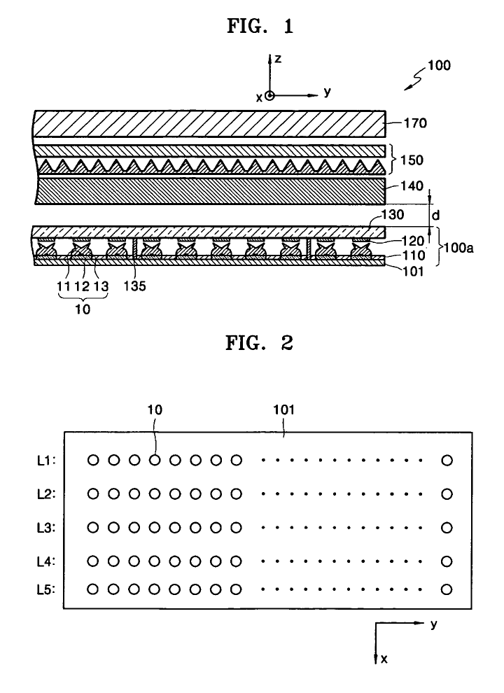

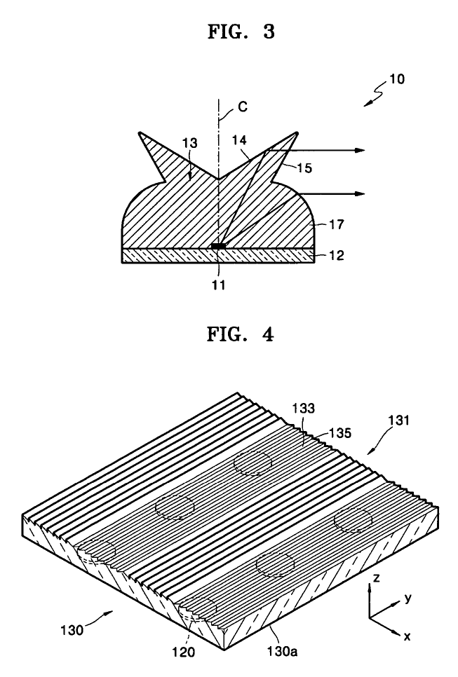

FIG. 1 is a schematic sectional view illustrating a backlight unit 100 according to an embodiment of the present general inventive concept, FIG. 2 is a plan view illustrating an exemplary arrangement of light emitting units 10 of the backlight unit 100 of FIG. 1, and FIG. 3 is an enlarged sectional view illustrating one of the light emitting units 10 of the backlight unit 100 of FIG. 1.

Referring to FIGS. 1 through 3, the backlight unit 100 includes a plurality of light emitting units 10 arranged in an array on a base plate 101, an optical plate 130 disposed above the plurality of light emitting units 10, and a light transmission diffusion plate 140 disposed above the optical plate 130 to diffuse and transmit incident light. Additionally, the backlight unit 100 may further include a reflection diffusion plate 110 disposed at a lower side of the plurality of light emitting units 10 to diffuse and reflect the incident light. The following description assumes that an upward direction is a main traveling direction of light emitted from a light emitting diode (LED) chip 11 of each of the light emitting units 10. The main traveling direction of the light emitted from the LED chip 11 substantially corresponds to a central axis of the light emitting unit 10.

The base plate 101 serves as a substrate on which to mount the plurality of light emitting units 10 in a 2-dimentional array. The base plate 101 may be a printed circuit board (PCB) installed so as to electrically connect the LED chip 11 of the light emitting unit 10. Alternatively, the backlight unit 100 may have a separate PCB for operation of the light emitting units 10 that is independent of the base plate 101.

Referring to FIG. 2, the plurality of light emitting units 10 are arranged in the 2-dimentional array on the base plate 101. In particular, the plurality of light emitting units 10 are arranged in an array to form at least one line, i.e., n-number of lines L1-Ln (n≧1). FIG. 2 illustrates an example arrangement having the plurality of light emitting units 10 arranged in 5-line array (L1-L5).

The plurality of light emitting units 10 are arranged such that an interval between the lines of the light emitting units 10 is wider than the light emitting units 10 arranged in each line. A number of lines of the plurality of light emitting units 10, a number of the light emitting units 10 arranged in each line, the interval between the light emitting units 10 in each line, or the like may be varied depending on design conditions.

As mentioned above, the plurality of light emitting units 10 are arranged in the 2-dimentional array on the base plate 101 to form one or more lines. The plurality of light emitting units 10 emit R (red), G (green), and B (blue) lights and may be alternately arranged in each line. In this case, R, G, and B light emitting diode chips (i.e., the LED chips 11) are respectively used as the R, G and B light emitting units 10. A number of each of the R, G, and B light emitting units 10 in each line may be varied according to a number of R, G, and B lights emitted from each of the R, G, and B light emitting units 10.

An amount of R, G, and B lights emitted from each of the R, G, and B light emitting diode chips 11 may be different from each other. In particular, the amount of G light emitted from the G light emitting diode chip 11 may be less than the amount of R and B lights emitted from the R and B light emitting diode chips 11, respectively. Thus, on each line the R and B light emitting units 10 may be arranged in an equal number, and the G light emitting units 10 may be arranged in a number that is two times greater than the number of each of the R and B light emitting units 10. For example, the R, G, and B light emitting units 10 may be arranged as a sequence of R, G, G, and B or a sequence of B, G, G, and R in each line.

Alternatively, the light emitting units 10 may include light emitting diode chips 11 each emitting white light.

The plurality of light emitting units 10 are alternately arranged using the light emitting diode chips 11 to emit the R, G and B lights or are arranged using the light emitting diode chips 11 to emit the white light such that the backlight unit 100 emits the white light. Accordingly, an LCD employing the backlight unit 100 can display color images.

As illustrated in FIG. 3, each light emitting unit 10 may include the light emitting diode chip 11 to emit light, and a collimator to collimate light incident from the light emitting diode chip 11. FIG. 3 illustrates an example of the light emitting unit 10 including a side emitter 13 provided as the collimator that directs the incident light to travel toward an approximate side direction.

The light emitting diode chip 11 can be coupled with the side emitter 13 and disposed on a base 12.

The side emitter 13 may be disposed in close contact with the light emitting diode chip 11. Accordingly, an amount of light that is emitted from the light emitting diode chip 11 and is then incident into the side emitter 13 can be maximized.

The side emitter 13 has a transparent body and is made of transparent material. As illustrated in FIG. 3, the side emitter 13 may include a reflection surface 14 shaped as a funnel inclined with respect to a central axis (C) of the LED chip 11, a first refraction surface 15 inclined with respect to the central axis (C) of the LED chip 11 to refract and transmit light that is reflected by the reflection surface 14, and a second refraction surface 17 extending from the base 12 to the first refraction surface 15 and having a convex shape. Light that is emitted from the light emitting diode chip 11 and then travels toward the reflection surface 14 of the side emitter 13 is reflected by the reflection surface 14, travels toward the first refraction surface 15, and is transmitted by the first refraction surface 15. The light transmitted by the first refraction surface 15 then travels toward the approximate side direction. Additionally, light that is emitted from the light emitting diode chip 11 and travels toward the second refraction surface 17 is transmitted through the second refraction surface 17 and also travels toward the approximate side direction.

The side emitter 13 may have various shapes that emit the light incident from the light emitting diode chip 11 toward the approximate side direction.

Most of the light emitted from the light emitting diode chip 11 of the light emitting unit 10 is directed toward the approximate side direction by the side emitter 13. However, some of the emitted light passes through the reflection surface 14 of the side emitter 13 and travels in the upward direction. The amount of the emitted light that travels in the upward direction of the side emitter 13 may be, for example, about 20% of a total amount of light emitted from the light emitting diode chip 11.

For example, even though the reflection surface 14 of the side emitter 13 is formed to satisfy a condition of total internal reflection, it may not be possible to completely satisfy the condition of total internal reflection with respect to all light, since the light emitted from the LED chip 11 is dispersed in many directions. Accordingly, some of the emitted light passes through the side emitter 13 and travels in the upward direction without being redirected toward the approximate side direction. Additionally, although the reflection surface 14 is formed by a reflection coating, it may be difficult to form a coating such that the reflection surface 14 becomes a complete total reflection surface. Thus, the reflection surface 14 may be coated to provide a proper reflectivity. Accordingly, some light travels directly in the upward direction of the side emitter 13 without being reflected by the reflection surface 14.

The light that travels in the upward direction of the side emitter 13 causes a light spot or a brightness line to appear at the position of the light emitting diode chip 11 when the backlight unit is 100 viewed from an upper portion thereof. Additionally, when the R, G and B light emitting units 10 that emit the R, G and B lights are arranged to reproduce their corresponding colors, the R, G, and B colors may appear.

Referring to FIGS. 1 and 3, the optical plate 130 may have a plurality of reflection mirrors 120 formed at a lower surface to face the plurality of light emitting units 10 to reflect light emitted in the upward direction such that the emitted light does not directly travel toward the light transmission diffusion plate 140.

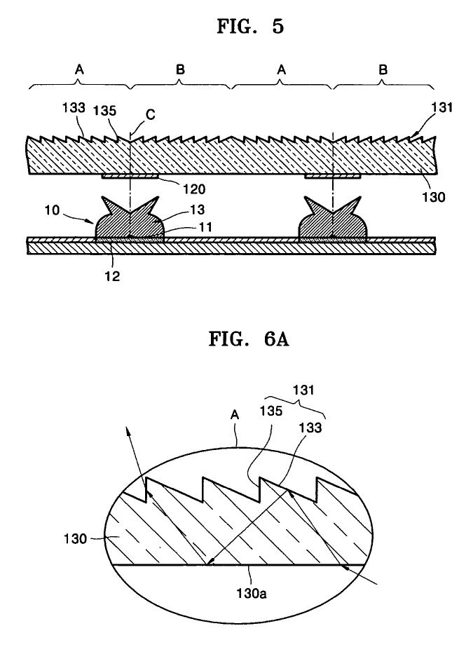

In addition, the optical plate 130, as illustrated in FIGS. 4 and 5, includes a saw-tooth reflection/refraction pattern 131 formed at an upper surface thereof such that the incident light is spread at a wider angle by reflection.

FIG. 4 is a schematic perspective view illustrating the optical plate 130 of the backlight unit 100 of FIG. 1 according to an embodiment of the present general inventive concept, and FIG. 5 is a partial side sectional view illustrating the backlight unit 100 of FIG. 1 according to an embodiment of the present general inventive concept. Specifically, FIG. 5 schematically illustrates a positional relationship between the reflection/refraction pattern 131 of the optical plate 130 and the plurality of light emitting units 10 arranged in each line.

The reflection/refraction pattern 131 is a saw-tooth pattern including a first local plane 133 inclined to totally internally reflect at least part of the incident light, and a second local plane 135 to form a saw-tooth shape together with the first local plane 133 and to refract and transmit the incident light. A length direction along which the first and second local planes 133 and 135 of the reflection/refraction pattern 131 extend is parallel with the lines L1-L5 each including the plurality of light emitting units 10 as illustrated in FIG. 2. The first and second local planes 133 and 135 may be shaped as stripes along the optical plate 130.

The reflection/refraction pattern 131 includes first pattern regions ‘A’ and second pattern regions ‘B’ alternately repeating such that the first local plane 133 has an opposite inclination in the first pattern regions ‘A’ and the second pattern regions ‘B’ and an intersection point of the first and second pattern regions ‘A’ and ‘B’ is centered on each of the lines L1-L5 crossing a central axis (C) of the plurality of light emitting units 10. The first local plane 133 in each of the first and second pattern regions ‘A’ and ‘B’ is inclined in a direction to extend away from the central axis of the plurality of light emitting units 10.

In this case, the first and second pattern regions ‘A’ and ‘B’ are positioned on the right and on the left of each of the lines L1-L5, respectively, to intersect at the center (‘line axis’) of each of the lines L1-L5 crossing the central axes (C) of the plurality of light emitting units 10. The second pattern region ‘B’ and the first pattern region ‘A’ are positioned between the line axes of the lines L1-L5 of the light emitting units 10.

Referring to FIG. 5, the first local plane 133 is formed inclined toward a left upward direction in the first pattern region ‘A’ positioned to the left of each line L1-L5 (i.e., defined by the line axes), and the first local plane 133 is inclined toward a right upward direction in the second pattern region ‘B’ positioned to the right of each line L1-L5.

The saw-tooth shape of the reflection/refraction patter 131 including the first local plane 133 and the second local plane 135 having oppositely inclined directions is described as follows.

The LED chip 11 of the light emitting unit 10 emits light in many directions. Most of the light emitted through the side emitter 13 is redirected toward the approximate side direction.

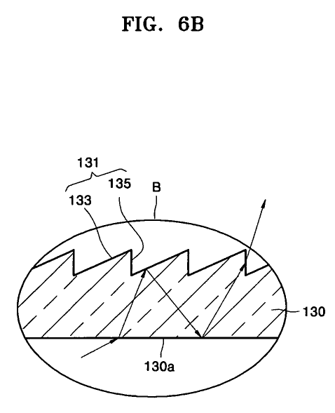

As illustrated in FIGS. 6A and 6B, most light incident on the optical plate 130 travels toward the left and right upward directions. FIG. 6A is a schematic view illustrating a traveling path of light that is incident on the first local plane 133 of the first pattern region ‘A’, and FIG. 6B is a schematic view illustrating a traveling path of light that is incident on the first local plane 133 of the second pattern region ‘B’. Referring to FIGS. 6A and 6B, of the light that is emitted into the optical plate 130 through a lower surface 130a thereof, light that is incident at an angle that satisfies the condition of total internal reflection with respect to the first local plane 133 is reflected by the first local plane 133 and is then incident back on the lower surface 130a of the optical plate 130. Thereafter, the incident light is again totally internally reflected by the lower surface 130a, travels toward the second local plane 135, and is refracted and transmitted by the second local plane 135. However, some of the incident light may be totally internally reflected by the lower surface 130a of the optical plate 130 and may again be incident on the first local plane 135.

Herein, the light that is emitted into the optical plate 130 includes light that is emitted from the light emitting units 10, and is then directly incident on the optical plate 130, and light that is reflected by the reflection diffusion plate 110 and is then incident on the optical plate 130. The light that is reflected by the reflection diffusion plate 110 includes both light that is reflected by the reflection mirror 120 of the optical plate 130 and then travels back toward the reflection diffusion plate 110, and light that is directly incident on the reflection diffusion plate 110 from the light emitting units 10.

As illustrated in FIGS. 4 and 5, when the reflection/refraction pattern 131 is formed as a structure having the first and second pattern regions ‘A’ and ‘B’ formed at the left and right of each line axis of the light emitting units 10 and including the first local plane 133 inclined at opposite directions with respect to the line axis, most of the light traveling toward the left upward and the right upward directions can be incident on the first local plane 133 at an angle that satisfies the condition of total internal reflection. Accordingly, the incident light is totally internally reflected by the first local plane 133. The internally reflected light may again be reflected by the lower surface 130a of the optical plate 130 to be redirected on another first local plane 133, thereby repeating the above operation. Alternatively, the internally reflected light may be refracted and transmitted by the second local plane 135 and travel toward the light transmission diffusion plate 140.

If the first local plane 133 of the reflection/refraction pattern 131 is inclined in only one direction over an entire area of the optical plate 130, most of the light traveling in a direction opposite to the inclined direction of the first local plane 133 is not totally internally reflected due to a small incident angle on the first local plane 133. As a result, some of the light is transmitted (and not reflected) by the first local plane 133, so that the light is not spread as well as when the first local plane 133 is inclined in both directions (as illustrated in FIGS. 4 and 5). However, even the arrangement described above, in which the first local plane 133 is inclined in a single direction over the entire area of the optical plate 130, will still spread light incident thereon wider than when the reflection/refraction pattern 131 is not provided at all.

The first local plane 133 may be configured to form a relatively small inclination angle with respect to the lower surface 130a of the optical plate 130 so as to satisfy the condition of total internal reflection with respect to at least some of the incident light. However, the second local plane 135 may be configured to form a greater inclination angle than that of the first local plane 133 with respect to the lower surface 130a of the optical plate 130. In this case, the first local plane 133 has a greater width than the second local plane 135.

A slope of the first local plane 133 may be optimized at an angle that can totally internally reflect a maximum amount of light. Additionally, a slope of the second local plane 135 may be optimized at an angle that can refract and transmit a maximum amount of light.

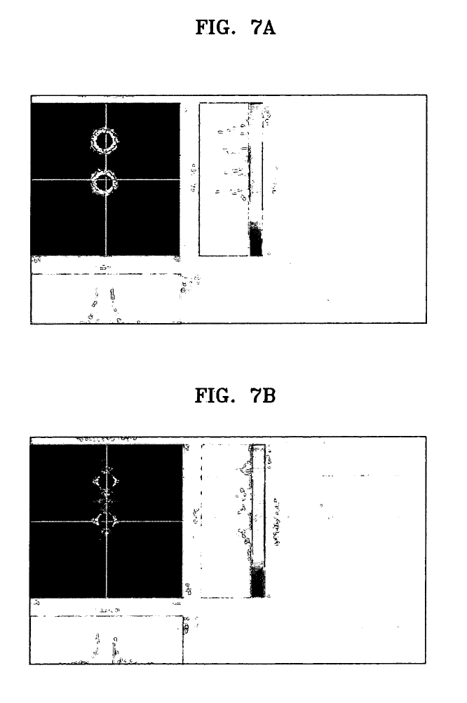

FIGS. 7A and 7B respectively illustrate intensity distributions of light above an optical plate when the saw-tooth reflection/refraction pattern 131 is not formed on the upper surface thereof and the optical plate 130 when the saw-tooth reflection/refraction pattern 131 is formed on the upper surface thereof. FIGS. 7A and 7B illustrate results obtained from a simulation performed in which two reflection mirrors are disposed at positions of the lower surface 130a of the optical plate 130 to correspond to the two LEDs disposed therebelow. A central bright light is shielded by the two reflection mirrors.

Comparing FIG. 7A with FIG. 7B, it can be seen that light emitted into the optical plate 130 having the saw-tooth reflection/refraction pattern 131 formed thereon (FIG. 7B) is spread at a wider angle than light emitted into the optical plate not having the saw-tooth reflection/refraction pattern 131 formed thereon.

Thus, since the light can be spread at a wider angle when the optical plate 130 includes the reflection/refraction pattern 130, an interval between the light transmission diffusion plate 140 and the light emitting units 10 (i.e., an interval ‘d’ between the light transmission diffusion plate 140 and a lower portion 100a of the backlight unit 100) can be reduced. Thus, it becomes possible to make a thickness of the backlight unit 100 sufficiently thin and still be able to uniformly irradiate light.

Of the light that is emitted into the optical plate 130, some of the incident light is totally reflected inside the optical plate 130. As illustrated in FIGS. 6A and 6B, the incident light is totally internally reflected once by the first local plane 133, and is then transmitted through the second local plane 135. The incident light may then be totally internally reflected again by the lower surface 130a of the optical plate 130. The light that is emitted into the optical plate 130 may be totally internally reflected by the first local plane 133 two or more times, and may then be refracted and transmitted by the second local plane 135.

As a result of the incident light being totally internally reflected as described above, the light emitted from the light emitting units 10 is spread at a wider angle.

Of the light that is incident on the optical plate 130, a first light is incident on the first local plane 133 at an angle that does not satisfy the condition of total internal reflection and is transmitted through the reflection/refraction pattern 131, and a second light is incident on the first local plane 133 and is reflected by the reflection/refraction pattern 131. The first refracted light and the second reflected light may have a predetermined ratio with each other. The second reflected light may again be reflected by the lower surface 130a of the optical plate 130 toward the reflection/refraction pattern 131.

The optical plate 130 having the structure described above serves as a diffusion plate due to an interaction between the reflection/refraction pattern 131 and the lower surface 130a thereof.

The plurality of reflection mirrors 120 and a body of the optical plate 130 having the reflection/refraction pattern 131 are made of transparent material, for example, transparent PMMA (polymethylmethacrylate).

Referring back to FIG. 1, the plurality of reflection mirrors 120 may be spaced from the light emitting units 10 by a first predetermined distance. In order to maintain the first predetermined distance between the plurality of reflection mirrors 120 and the light emitting units 10, the optical plate 130 may be supported by a supporter 135. The supporter 135 supports the optical plate 130 with respect to the reflection diffusion plate 110 and/or the base plate 101.

The reflection diffusion plate 110 diffuses and reflects incident light such that the incident light travels in the upward direction. The reflection diffusion plate 110 is disposed on the base plate 101 to be positioned below the light emitting units 10. Accordingly, the reflection diffusion plate 110 has a plurality of holes in which the plurality of light emitting units 10 are disposed, and is mounted on the base plate 101 once the light emitting units 10 are inserted into the holes. It should be understood that the “upward direction” referred to throughout this description represents a reference direction and is not intended to limit the scope of the present general inventive concept. The “upward direction” may actually refer to a lateral or horizontal direction, when the backlight unit 100 is mounted in a display panel apparatus.

The light transmission diffusion plate 140 is positioned to be spaced apart by a second predetermined distance from the lower portion 100a of the backlight unit 100. The light transmission diffusion plate 140 diffuses and transmits incident light.

If the light transmission diffusion plate 140 is too close to the light emitting units 10, a portion where the light emitting units 10 are positioned appears to be brighter than a remaining portion where the light emitting units 10 are not positioned such that uniformity in brightness may deteriorate. Additionally, the further the light transmission diffusion plate 140 is positioned from the light emitting units 10, the thicker the backlight unit 100 is made. Accordingly, the second predetermined distance (i.e., a separation distance between the light transmission diffusion plate 140 and the lower portion 100a of the backlight unit 100 including the light emitting units 10) may be set to a minimum value within a range at which lights can be effectively mixed to a desired degree by light diffusion.

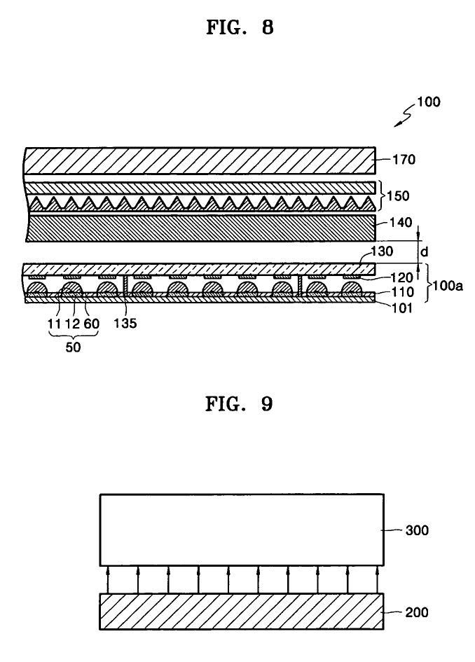

Referring to FIGS. 1 and 8, the backlight unit 100 according to an embodiment of the present general inventive concept may further include a brightness enhancement film (BEF) 150 to enhance a directivity of light emitted from the light transmission diffusion plate 140. In addition, the backlight unit 100 may further include a polarization enhancement film 170 to enhance a polarization efficiency of light incident from the BEF 150 and/or the light transmission diffusion plate 140.

The BEF 150 refracts and focuses the light emitted from the light transmission diffusion plate 140 to enhance the directivity of the light, thereby enhancing the brightness thereof.

The polarization enhancement film 170 enhances the polarization efficiency by, for example, transmitting p-polarized light and reflecting s-polarized light, so that most of the light incident from the BEF 150 is transmitted therethrough in one polarization state, for example, p-polarized state.

FIG. 8 is a schematic view illustrating a backlight unit 100 according to another embodiment of the present general inventive concept. Although the above embodiments illustrate and describe that the backlight unit 100 is provided with the light emitting units 10 having the side emitter 13 that functions as a collimator, the backlight unit 100 may alternatively include a plurality of light emitting units 50 having a dome-shaped collimator 60. The backlight unit 100 illustrated in FIG. 8 has substantially the same components as that of the backlight unit 100 of FIG. 1 except for the plurality of light emitting units 50 each having the dome-shaped collimator 60. Accordingly, similar components are represented by similar reference numerals, and a description thereof will not be provided.

FIG. 9 schematically illustrates an LCD apparatus having a backlight unit 200 according to an embodiment of the present general inventive concept. Referring to FIG. 9, the LCD apparatus includes the backlight unit 200 and a liquid crystal panel 300 disposed on the backlight unit 200. The liquid crystal panel 300 allows light that is linearly polarized in one state to be incident on a liquid crystal layer of the liquid crystal panel 300 and changes a direction of a liquid crystal director using an electric field to drive a polarization change of the light passing through the liquid crystal layer, thereby displaying image information. The liquid crystal panel 300 is connected to a driving circuit part. Since detailed constructions and display operations of the liquid crystal panel 300 should be known to those skilled in the art, a detailed description thereof will not be provided.

As the light incident on the liquid crystal panel 300 is modified to have a single polarization state, it is possible to enhance light usage efficiency. By providing the polarization enhancement film 170 (see FIGS. 1 and 8) on the backlight unit 100 or 200, it is possible to enhance the light usage efficiency.

As described above, according to the various embodiments of the present general inventive concept, it is possible to make a brightness distribution of light uniform over an entire area of a backlight unit, while making a thickness of the backlight unit sufficiently thin. Accordingly, by employing the backlight unit in the LCD apparatus, an overall thickness of the LCD apparatus can also be made thinner and a good quality image having the uniform brightness over the entire area of the LCD apparatus can be obtained.

When using a direct light type backlight unit according to the various embodiments of the present general inventive concept, an optical plate having a reflection/refraction pattern makes it possible to create the backlight unit to have a thickness that is sufficiently thin such that the backlight unit can still uniformly irradiate light, thereby sufficiently satisfying desired slim design requirements.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A backlight unit usable with a display panel apparatus, the backlight unit comprising:
a base plate;
a plurality of light emitting units arranged on the base plate to form at least one line;
an optical plate disposed above the plurality of light emitting units including a plurality of reflection mirrors formed at a lower surface thereof to face the plurality of light emitting units and to reflect light emitted directly upward from the plurality of light emitting units, and a saw-tooth reflection/refraction pattern formed at an upper surface thereof to spread incident light at a wide angle; and
a light transmission diffusion plate disposed on the optical plate to diffuse and transmit incident light.

2. The backlight unit of claim 1, wherein the saw-tooth reflection/refraction pattern includes a first local plane inclined to totally internally reflect at least part of the incident light and a second local plane to form a saw-tooth shape together with the first local plane, and the first and second local planes being arranged in stripes along the upper surface of the optical plate.

3. The backlight unit of claim 2, wherein each of the stripes in which the first and second local planes are arranged extend along a length direction that is parallel with the at least one line of the plurality of light emitting units.

4. The backlight unit of claim 2, wherein the saw-tooth reflection/refraction pattern comprises first pattern regions and second pattern regions alternately repeated such that the first local plane has an opposite inclination direction in the first pattern regions and the second pattern regions and the first and second pattern regions center on a line crossing a central axis of the plurality of light emitting units.

5. The backlight unit of claim 4, wherein the first local plane in each of the first and second pattern regions is inclined in a direction that extends away from the central axis of the plurality of light emitting units.

6. The backlight unit of claim 2, wherein the second local plane refracts and transmits the incident light.

7. The backlight unit of claim 2, wherein the first local plane has an inclination angle with respect to the lower surface of the optical plate that is smaller than an inclination angle of the second local plane with respect to the lower surface of the optical plate.

8. The backlight unit of claim 1, further comprising:
a light reflection-diffusion plate disposed on the base plate at a lower side of the plurality of light emitting units to diffuse and reflect the incident light toward the optical plate.

9. The backlight unit of claim 8, wherein each of the plurality of light emitting units comprises:
a light emitting diode chip to generate light; and
a collimator to collimate the light generated by the light emitting diode chip.

10. The backlight unit of claim 9, wherein the collimator comprises a side emitter to direct incident light to travel in an approximate side direction.

11. The backlight unit of claim 9, wherein the collimator is shaped as a dome.

12. The backlight unit of claim 1, further comprising:
at least one of a brightness enhancement film to enhance directivity of light emitted from the light transmission diffusion plate and a polarization enhancement film to enhance polarization efficiency of light incident from the light transmission diffusion plate.

13. A backlight unit usable with a display panel, the backlight unit comprising:
a light source to generate light beams; and
a refraction/reflection component to receive the generated light beams and to internally reflect a first one or more light beams and to refract a second one or more light beams to produce uniform light.

14. The backlight unit of claim 13, wherein the light source comprises:
a base plate;
a plurality of light emitting diodes arranged in a two dimensional array; and
a plurality of collimators to direct the light beams in various directions such that a majority of the light beams are directed in a side direction.

15. The backlight unit of claim 14, wherein the refraction/reflection component comprises:
a transparent body; and
a plurality of reflectors disposed on a bottom surface of the transparent body to reflect light beams received from the plurality of collimators back toward the plurality of light emitting diodes.

16. The backlight unit of claim 14, wherein the plurality of collimators are shaped as one of a dome and a convex shape having at least one reflection surface and at least one refraction surface extending therefrom to meet and form at least one funnel shape.

17. The backlight unit of claim 16, wherein the convex shape is symmetrical and the at least one funnel shape comprises a first funnel shape on a left side of the collimator to redirect the light beams toward the left side and a second funnel shape on a right side of the collimator to redirect the light beams toward the right side.

18. The backlight unit of claim 13, wherein the refraction/reflection component comprises:
a transparent plate having a first plurality of surfaces disposed on an upper portion thereof and being inclined in a first direction to internally reflect the light beams within the transparent plate, and a second plurality of surfaces disposed on the upper portion thereof inclined in a second direction to transmit the light beams therethrough.

19. The backlight unit of claim 18, further comprising:
a light transmission diffusion plate to receive light from the refraction/reflection component and to diffuse the received light;
a brightness enhancement film to enhance a directivity of light received from the light transmission diffusion plate; and
a polarization enhancement film to enhance a polarization efficiency of light received from the brightness enhancement film.

20. The backlight unit of claim 13, further comprising:
a base plate having a plurality of point light sources arranged in one or more lines thereon,
wherein the refraction/reflection component receives light through a bottom portion thereof and includes a saw-tooth surface on an upper portion thereof including a plurality of first region patterns having plane surfaces disposed along a first direction and a plurality of second region patterns having plane surfaces disposed along a second direction opposite to the first direction, and the first and second region patterns meeting along an axis of the one or more lines of the point light sources.

21. A backlight unit usable with a display panel apparatus, the backlight unit comprising:
a base;
an array of light sources disposed on the base to emit light beams in a predetermined direction; and
an optical plate disposed adjacent to the array of light sources and including an entrance surface and an exit surface such that one or more of the light beams reflect one or more times between the entrance surface and the exit surface and transmit in the predetermined direction through the exit surface.

22. The backlight unit of claim 21, further comprising:
a reflection diffusion plate disposed on the base to reflect any light beams that are reflected back toward the array of light sources.

23. The backlight unit of claim 21, wherein the exit surface comprises a transparent saw-tooth shape including one or more internally reflective surfaces and one or more refractive surfaces such that the one or more light beams that are transmitted in the predetermined direction therethrough create a uniform brightness.

24. The backlight unit of claim 21, wherein the optical plate further comprises a plurality of reflectors disposed on a bottom surface thereof to reflect one or more light beams from the array of light sources back toward the array of light sources.

25. A direct type backlight unit usable with a display panel apparatus, the backlight unit comprising:
a base having a plurality of light sources arranged thereon to emit a plurality of light beams; and
a reflection/refraction component disposed adjacent to the base and having a plurality of angled surfaces to receive the plurality of light beams, to reflectively scatter the light beams, and to output the scattered light beams as uniform light.

26. The backlight unit of claim 25, wherein the light beams are scattered within the reflection/refraction component until the light beams are incident on the plurality of angled surfaces at an angle such that total internal reflection does not occur and the light beams are transmitted through the plurality of angled surfaces.

27. An LCD apparatus, comprising:
a liquid crystal panel; and
a backlight unit to irradiate light toward the liquid crystal panel, the backlight unit comprising:
a base plate,
a plurality of light emitting units arranged on the base plate to form at least one line,
an optical plate disposed above the plurality of light emitting units including a plurality of reflection mirrors formed at a lower surface thereof to face the plurality of light emitting units to reflect light emitted directly upward from the plurality of light emitting units, and a saw-tooth reflection/refraction pattern formed at an upper surface thereof to spread incident light at a wide angle, and
a light transmission diffusion plate disposed on the optical plate to diffuse and transmit incident light.

28. The LCD apparatus of claim 27, wherein the saw-tooth reflection/refraction pattern includes a first local plane inclined to totally internally reflect at least part of the incident light and a second local plane to form a saw-tooth shape together with the first local plane, and the first and second local planes being arranged in stripes along the upper surface of the optical plate.

29. The LCD apparatus of claim 28, wherein each of the stripes in which the first and second local planes are arranged extend along a length direction that is parallel with the at least one line of the plurality of light emitting units.

30. The LCD apparatus of claim 28, wherein the saw-tooth reflection/refraction pattern comprises first pattern regions and second pattern regions alternately repeated such that the first local plane has an opposite inclination direction in the first pattern regions and the second pattern regions and the first and second pattern regions center on a line crossing a central axis of the plurality of light emitting units.

31. The LCD apparatus of claim 30, wherein the first local plane in each of the first and second pattern regions is inclined in a direction that extends away from the central axis of the plurality of light emitting units.

32. The LCD apparatus of claim 28, wherein the second local plane refracts and transmits the incident light.

33. The LCD apparatus of claim 28, wherein the first local plane has an inclination angle with respect to the lower surface of the optical plate that is smaller than an inclination angle of the second local plane with respect to the lower surface of the optical plate.

34. The LCD apparatus of claim 27, further comprising:
a light reflection-diffusion plate disposed on the base plate at a lower side of the plurality of light emitting units to diffuse and reflect the incident light toward the optical plate.

35. The LCD apparatus of claim 34, wherein each of the plurality of light emitting units comprises:
a light emitting diode chip to generate light; and
a collimator to collimate light generated by the light emitting diode chip.

36. The LCD apparatus of claim 35, wherein the collimator comprises a side emitter to direct incident light to travel in an approximate side direction.

37. The LCD apparatus of claim 35, wherein the collimator is shaped as a dome.

38. The LCD apparatus of claim 27, further comprising:
at least one of a brightness enhancement film to enhance a directivity of light emitted from the light transmission diffusion plate and a polarization enhancement film to enhance polarization efficiency of the light emitted from the light transmission diffusion plate.

39. A display panel apparatus, comprising:
a display panel; and
a backlight unit to irradiate the display panel, the backlight unit comprising:
a light source to generate light beams, and
a refraction/reflection component to receive the generated light beams and to internally reflect a first one or more light beams and to refract a second one or more light beams to produce uniform light.
